(19) United States
(12) Patent Application Publication
(10) Pub. No.: US 2013/0317854 A1
(43) Pub. Date: Nov. 28, 2013

(54) METHOD AND SYSTEM TO ASSOCIATE PATIENTS WITH PATIENT DATA

(71) Applicants: Horst Winder, Marloffstein (DE); Marcus Wuebbe, Herzogenaurach (DE)

(72) Inventors: Horst Winder, Marloffstein (DE); Marcus Wuebbe, Herzogenaurach (DE)

(21) Appl. No.: 13/901,904

(22) Filed: May 24, 2013

(30) Foreign Application Priority Data
May 25, 2012 (DE) 102012208817.2

(51) Int. Cl. G06F 19/00; G06Q 50/24

(52) U.S. Cl. CPC G06F 19/322; G06Q 50/24
USPC 705/3

(57) ABSTRACT

A method and information system to support the association of a patient with a patient data set at at least one computer, a photograph of the patient is obtained and stored in a manner that links the photograph with the patient data set. Upon at least one, and preferably at every, treatment requiring the presence of the patient, the photograph of the patient is visually presented at a display device that is in the field of view of a person implementing or supervising the treatment.

### BACKGROUND OF THE INVENTION

1. Field of the Invention

The invention concerns a method to assist the association of a patient with a patient data set at at least one computer. The invention also concerns an information system with at least one computer connected thereto to implement such a method.

2. Description of the Prior Art

Medical devices—in particular medical image acquisition apparatuses—generally use patient-specific data in order to control the medical device depending on the patient data. For example, in the case of x-ray devices it is known to enter the size and weight of a patient into a control computer in order to accordingly adjust radiation parameters and other image acquisition parameters. It is also known to relay patient data (for example an examination and/or treatment to be conducted) via a hospital information system to a computer of the medical device, from which an operator accepts or derives additional information and settings.

Patient data can be registered at the medical device or already in the patient registration, for example as an input via a keyboard or in corresponding forms presented at a display device.

Information systems—for example radiological information systems (RIS) or hospital information systems (HIS)—are known in the prior art. In these systems the patient is registered centrally, and the information requirement at the medical device and the transfer of the patient data (that are assembled into a patient data set) take place via a network, for example depending on a workflow. A local patient registration then no longer occurs at the medical device.

In such environments there is a risk that a mix-up of the patient can occur, which means that a patient data set is associated with the wrong patient. For example, it can then occur that an incorrect examination is conducted on a patient given a wrong association of patient data with patients, which means not only a loss of time but also high costs. It can even occur that misunderstandings and problems arise given a wrong association of a finding with a patient during the communication of findings.

Although such problems can be precluded in principle by appropriate care on the part of the relevant personnel, there can still be mix-ups, in particular in stressful situations or in the case of a large amount of patients and patient data sets.

### SUMMARY OF THE INVENTION

An object of the invention is to provide a method that assists operators in the association of patient data with specific patients.

This object is achieved in accordance with the invention in a method of the aforementioned type wherein a photograph of the patient is obtained and stored in association with the patient data set, and in the case of at least one (preferably all) treatment requiring the presence of the patient, the photograph of the patient is presented at a display device that is either used for implementing the treatment or that is present in the field of view of an operator who performs or supervises the treatment.

According to the invention the patient data set is linked with a photograph (thus a real image of the patient) that ideally is always displayed when an association of patient data with an actually present patient must take place. The photograph of the patient can consequently accompany the patient through the entire workflow of an examination or a residence in a medical facility (for example a physician's practice or clinic) so that the verifying person can immediately optically recognize whether the correct patient who belongs to the patient data is actually present. The danger of a mix-up is thus markedly reduced, and the safety for the patient can be markedly increased.

Because an optical comparison now exists, a mix-up of the patient is nearly impossible. A real image differing from the person who is present—consequently a photograph that does not show the present person—would inevitably be conspicuous, such that it can be concluded that the person who is present is not the patient associated with the patient data set. A mix-up is also precluded in practice in the communication of findings.

The method according to the invention is naturally implemented wholly automatically, in particular by an information system (discussed in more detail in the following) which includes suitable storage devices for the patient data set and the photograph of the patient (such as computers) or offers a suitable access to computers.

A number of types of display devices are possibilities at which the photograph of the patient can be presented in the association of the patient data. For example, a patient data display of a medical imaging device (for example a magnetic resonance device) can be used as the display device. For example, such patient data displays can be provided within a magnetic resonance operating booth or cubicle. The display of the photograph is also possible at a monitor of a measurement console, also associated with a medical device. Additional conceivable display devices are monitors at finding and/or conference workstations.

In a further embodiment of the present invention, the patient data set is used and/or processed within the scope of a workflow with multiple steps (in particular of an examination), wherein a treatment requiring the presence of the patient is determined using respective presence information associated with a treatment step. As already mentioned, a workflow in which the photograph of the patient represents a “constant companion” can be associated with processes that are to be implemented with use or processing of the patient data set. For this purpose, presence information that indicate whether the presence of the patient is required can be associated with steps (for example of an image acquisition). Whenever this is the case, the photograph of the patient is always displayed. Similar steps in which the presence of a patient is required are the communication of findings, registrations and the like.

Alternatively, the photograph of the patient can be presented at every access to the patient data set. Independently of whether the patient is directly present, whether his or her presence is required, or whether he or she is absent, every access to the patient data set is then always supplemented by a presentation of the photograph, which can evoke recollections of the patient in the accessing person, such that a risk of confusion is reduced even in the absence of the patient.

As already indicated by examples, a registration of the patient and/or an image acquisition process with a medical image acquisition device and/or a finding communication appointment can be used as a treatment requiring the presence of the patient.

The photograph is preferably shown together with at least a portion of the data of the patient data set, in particular adjacent to personal data of the patient (in particular data displayed in a title bar). In addition to the comparison between the present patient and the photograph, an optical association of the patient data (a name, for example) with the photograph is thus promoted via simultaneous display of the patient data and the photograph at the display device. For example, if (in principle) a name of the patient is displayed in a defined presentation region of the display device (in a title bar, for example), the photograph can also be shown associated with this name. The most varied possibilities are conceivable.

It is also advantageous if—in addition to a presentation at a display device—the photograph is printed out on a printout accompanying the patient within a medical facility (in particular a clinic) and/or during an examination. Such routing slips are known in many medical facilities (for example clinics or physician's practices) and can consequently also be provided with the photograph, such that a certain association is also provided with regard to the routing slip. Furthermore, it is also advantageous to provide the photograph of a patient on a printout of a medical image of said patient, for example an x-ray image (what is known as a film sheet). Such printouts of medical images are frequently used by physicians in order to explain findings and the like and can likewise be provided with the photograph upon printout for certain association with a patient.

In order to obtain or acquire the photograph of the patient, the photograph of the patient can be taken with a dedicated digital camera. For example, within the scope of a patient registration at a medical facility (a clinic or a physician's practice, for example) a digital camera can thus be used in order to produce a real image of the patient specifically for the purpose of the present invention.

However, it is also possible for the photograph of the patient to be obtained by scanning a hard copy and/or from a data medium, in particular an electronic insurance card. It is thus also conceivable for the patient himself or herself to bring along a photograph to the patient registration, for example a digital photo stored on a data medium or even a hard copy that can then be scanned. Carrying a photograph on an electronic insurance card, which photograph is then usable in multiple medical facilities, can be particularly advantageous.

The photograph that is determined in such a manner can then be stored in the information system, for example in a database, and in fact be associated with the patient data set (in particular can also already be integrated into this data set). The photograph can therefore be retrieved and displayed at all connected computers, in particular thus in every step of a workflow.

In an embodiment of the present invention, the photograph can be converted into the DICOM format and stored accordingly.

The DICOM (digital imaging and communications in medicine) standard is the current prevalent standard that is used by many medical facilities, thus in particular clinics and physician's practices. The use of the DICOM standard enables access to a broad palette of applications that operate with this standard, for example image archiving systems (PACS) and the like.

For conversion, an image file of the photograph is stored in a database and a DICOM reference (pointer) object is generated. The database can be a database of an image archiving system (PACS) at which files can be accordingly accessed via DICOM objects that, for example, can be stored in a corresponding DICOM database.

As already mentioned, the computer advantageously forms a portion of the information system, in particular a radiology information system and/or a hospital information system. Such information systems in which patient data sets are carried within the scope of a workflow (for example through an entire examination) are widely known and do not need to be explained in detail herein.

As also noted, the photograph and/or the patient data set can be stored in a database that can be addressed from multiple computers, in particular a database of an image archiving system. As is the case for general databases for patient data sets, image archiving systems are known in the art.

In addition to the method, the invention also concerns an information system with at least one computer connected thereto (i.e., in communication therewith), the information system being designed (configured) to implement the method according to the invention. Such information systems are generally realized as a network structure in which a server or multiple servers with databases enable the central storage of data, in particular patient data sets and/or photographs as well. Special application programs allow access from the most varied computers, for example computers of medical devices and imaging devices. For example, the information system can be a radiology information system and/or a hospital information system.

All statements with regard to the method according to the invention apply analogously to the information system according to the invention with which the aforementioned advantages can consequently likewise be achieved.

### BRIEF DESCRIPTION OF THE DRAWINGS

FIG. 1 is a block diagram of an information system according to the invention.

FIG. 2 is a block diagram for explaining an embodiment of the method according to the invention.

FIG. 3 shows an example of a display within the scope of the method according to the invention.

### DESCRIPTION OF THE PREFERRED EMBODIMENTS

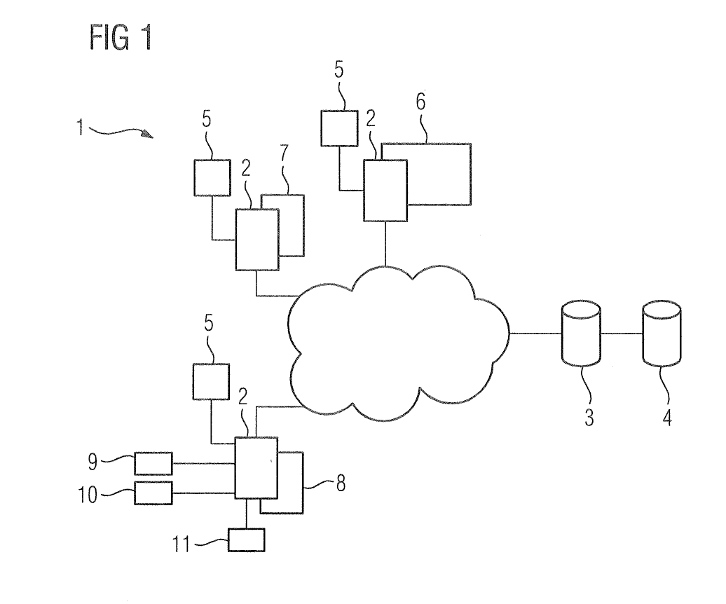

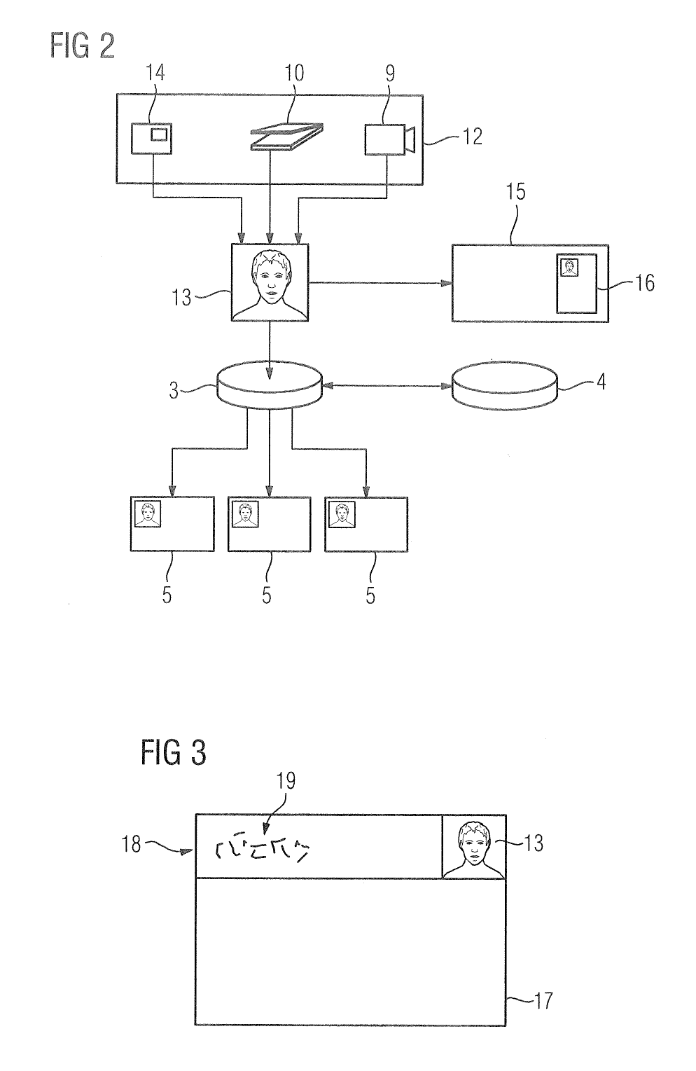

FIG. 1 shows a basic illustration of an information system 1 according to the invention, which can be a hospital information system or a radiology information system. The information system 1 is essentially a network to which various computers 2 are connected, but to which a central DICOM database 3 can also be connected via which images stored in an image archiving system (PACS) 4 can be accessed. Patient data sets that include patient-specific data can also already be stored in the database 3, and thus can be retrieved from every connected computer 2. The computers 2 (each of which has an associated display device 5) can be associated with various workstations and devices, for example a medical device 6 such as a magnetic resonance device, a finding workstation 7 or a patient registration workstation 8. Also provided at the patient registration workstation 8 are a digital camera 9, a scanner 10 and a card reader 11. The method according to the invention can be executed with the information system presented in FIG. 1. FIG. 2 explains the method according to the invention in this context.

In Step 12 (here within the scope of the patient registration) a photograph 13 of the patient is initially acquired in addition to other patient data that form the basis of the patient data set. At least three embodiments are conceivable for this purpose. It is possible to take the photograph 13 directly on site with the digital camera 9. It is also possible to use the scanner 10 in order to scan a hard copy of a photograph (brought along by the patient) and thus to obtain the digitally present photograph 13. It is also possible for the photograph 13 to be stored on a data medium 14 (for example an electronic insurance card) carried by the patient.

After registering the photograph 13, the photograph 13 is converted into the DICOM format, which means that a DICOM reference object is stored together with the patient data set in the database 3 so that the actual image file in the image archiving system 4 can be accessed. At this point in time it is also possible to generate a printout 16 (Step 15) which serves as a routing slip and on which the photograph 13 is likewise depicted. However, Step 15 is optional.

There are now multiple possibilities for further use of the photograph 13. The photograph 13 can be visually presented together with data of the patient data set at a display device 5 associated with a computer 2 upon every access to that patient data set. It is also possible for presence information to be associated with the various steps in a workflow that follows the linking of the photograph 13 with the patient data (for example in an examination). This presence information indicates whether the presence of the patient is required and consequently whether the photograph 13 should be displayed. In any case, the presentation of the photograph 13 on the display devices 5 together with data of the patient data set supports the association of the patient data with the patient, and thus avoids mix-ups.

For example, during a magnetic resonance examination the photograph 13 can be presented on a display in the shielded control booth, at the measurement console, at a display device of a finding workstation, and the like.

FIG. 3 shows an example of a presentation 17 in which the photograph 13 is displayed in a presentation region 18 (here a title bar) together with a name 19.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method to support association of a patient with patient data of the patient comprising:
obtaining a photograph of a patient and storing said photograph linked with an electronic patient data set of the patient; and
upon implementation of at least one medical treatment requiring a presence of the patient, automatically causing said photograph of the patient to be displayed at a display device within a field of view of a person participating in implementation of the treatment on the patient.

2. A method as claimed in claim 1 wherein said treatment comprises a workflow composed of multiple treatment steps, and deriving presence information from said photograph and requiring said presence information upon implementation of any of said multiple steps requiring the presence of the patient.

3. A method as claimed in claim 1 comprising allowing computerized access to said patient data set and automatically displaying said photograph of the patient of a display of every computer that accesses said patient data set.

4. A method as claimed in claim 1 comprising selecting said treatment requiring the presence of the patient from the group consisting of registration of the patient at a treatment facility, acquiring a medical image from the patient with a medical image acquisition device, and a diagnostic finding communication appointment.

5. A method as claimed in claim 1 comprising displaying said photograph at said computer together with at least a portion of data in said patient data set.

6. A method as claimed in claim 5 comprising displaying said photograph adjacent to personal data of the patient in a title bar.

7. A method as claimed in claim 1 comprising printing out said photograph in a printout and causing said printout to accompany said patient in a medical facility in which said at least one treatment is implemented.

8. A method as claimed in claim 1 comprising obtaining said photograph by a procedure selected from the group consisting of obtaining a digital image of the patient with a digital camera, electronically scanning a hard copy of a previous photograph of the patient, and electronically importing data representing said photograph from an electronic data medium.

9. A method as claimed in claim 1 comprising converting said photograph into a DICOM format and storing said photograph in said DICOM format linked with said patient data set also in said DICOM format.

10. A method as claimed in claim 9 comprising storing an image file of said photograph in a database and generating a DICOM reference object for said photograph stored in said database.

11. A method as claimed in claim 1 comprising accessing said photograph of the patient linked with the patient data set of the patient via a computer in communication with an information system selected from the group consisting of a radiology information system and a hospital information system.

12. A method as claimed in claim 1 comprising storing said photograph linked with said patient data set in a database that is accessible from a plurality of computers.

13. A method as claimed in claim 12 comprising storing said photograph and said patient data set in a database of an image archiving system.

14. An information system to support association of a patient with patient data of the patient comprising:
a database in which a photograph of a patient is stored, linked with an electronic patient data set of the patient; and
a computer configured, upon implementation of at least one medical treatment requiring a presence of the patient, to access said photograph and said patient data set and to cause said photograph of the patient to be displayed at a display device within a field of view of a person participating in implementation of the treatment on the patient.
